(19) United States
(12) Patent Application Publication
(10) Pub. No.: US 2015/0371023 A1
(43) Pub. Date: Dec. 24, 2015

(54) USAGE MODELING

(71) Applicant: UNIVERSITY OF PITTSBURGH OF THE COMMONWEALTH SYSTEM OF HIGHER EDUCATION, Pittsburgh, PA (US)

(72) Inventors: Yiran Chen, Pittsburgh, PA (US); Zhi-Hong Mao, Pittsburgh, PA (US); Kent W. Nixon, Bridgeville, PA (US)

(73) Assignee: University of Pittsburgh - Of the Commonwealth System of Higher Education, Pittsburgh, PA (US)

(21) Appl. No.: 14/767,485

(22) PCT Filed: Mar. 12, 2014
(86) PCT No.: PCT/US2014/024211

§ 371 Date: Aug. 12, 2015

Related U.S. Application Data
(60) Provisional application No. 61/779,970, filed on Mar. 13, 2013.

(51) Int. Cl. G06F 21/31; G06N 99/00

(52) U.S. Cl. CPC G06F 21/316; G06N 99/005

(57) ABSTRACT

Embodiments of techniques or systems for usage modeling or gesture based authentication are provided herein. Actions of a user may be captured, classified, and utilized to generate an authentication scheme for a device based on gesture recognition, gesture analysis, or action analysis. Training data may be determined based on actions deemed to be training actions and one or more action models may be generated based on the training data. An action model may be indicative of how a user performs a particular or predetermined action. When a security mode is enabled, usage actions may be recorded and usage data may be extracted or determined based on the usage actions. A usage action may be identified and corresponding usage data may be compared with training data from an appropriate action model. An identity of a user associated with the usage action may be determined based on this comparison.

### CROSS-REFERENCE TO RELATED APPLICATIONS

This application claims priority to pending PCT Application Serial No. PCT/US14/24211 entitled “USAGE MODELING,” filed Mar. 12, 2014 and claims the benefit of U.S. Provisional Patent Application, Ser. No. 61/779,970 (Attorney Docket No. 106852.103PRO) entitled “GESTURE MATCHING SECURITY SYSTEM”, filed on Mar. 13, 2013. The entirety of the above-noted application is incorporated by reference herein.

### BACKGROUND

Generally, devices are widely used in everyday life and often, sensitive information may be stored on these devices. Because of this, data security may be a concern for some users. As an example, a home may be protected by a home security system which accepts a PIN code. As another example, a mobile device or smartphone may be protected based on a password, a keypad lock, a PIN code, etc. To unlock or obtain access to the mobile device which is secured or has data protection enabled, a user may be required to input a swipe pattern or a four digit PIN, for example. When the correct pattern is entered or when the correct PIN is input, the device is unlocked.

Although data security may be a desirable feature, many individuals may not have a security protection mechanism enabled. For example, an individual may forget to setup the security protection mechanism, the individual may not understand how to setup security measures on his or her device, or the individual may not wish to take the time to enable security on his or her mobile device. This may be due to the fact that many security solutions often require active setup, extra operations, or additional operation to setup a security system in addition to normal operations. Other people may not want to setup security features on their devices because they may view the requirement to enter a PIN or a password as a hassle or an inconvenience, such as when these people wish to access features of a device quickly. Regardless, there is often a low adoption rate with regard to users implementing security features of many devices.

### BRIEF DESCRIPTION

This brief description is provided to introduce a selection of concepts in a simplified form that are described below in the detailed description. This brief description is not intended to be an extensive overview of the claimed subject matter, identify key factors or essential features of the claimed subject matter, nor is it intended to be used to limit the scope of the claimed subject matter.

One or more embodiments of systems or methods for usage modeling, gesture or action based authentication, or usage based customization or personalization is provided herein. In one or more embodiments, one or more actions of a user may be captured, classified, and utilized to generate an authentication scheme for a device based on gesture recognition or action recognition. For example, one or more actions or one or more interactions a user has with a device may be received, recorded, or captured. Characteristics, attributes, or data associated with one or more of the actions may be collected, captured, or determined, and training data may be derived therefrom. This training data from one or more of the actions may be utilized to build a database having one or more action models.

An action model may be indicative of how a user interacts (e.g., a typical action which may resemble a training action) with a device with regard to a predetermined action. Pattern recognition may be utilized to capture one or more patterns associated with an action of the user. In other words, input patterns associated with the user may be collected to facilitate generation of an action model. For example, an action model may contain or include data indicative of how a user swipes across a touch screen (e.g., the length or distance of an average swipe, how much pressure the user applies to the screen, which finger the user uses to swipe, etc.). As another example, an action model may be indicative of how quickly a user types (e.g., average number of words per minute). It will be appreciated, however, that an action may include a passive action, such as when a user merely holds or grasps the device, and action does not necessarily mean that the user is actively directing an input toward the device. Regardless, an action model may be utilized to recognize, identify, or authenticate an identity of a user, as the user interacts with a device (e.g., in real time).

In one or more embodiments, usage modeling or action models may evolve by accommodating changes in hardware, changes in biometric features, or changes in how a user interacts with a device. In other words, when a usage pattern is confirmed or when a usage action is authorized as ‘passing’, differences or changes between the confirmed usage actions and training actions or between usage data and training data may be utilized to train new action models or update existing action models in an ongoing fashion. In other embodiments, customization or personalization may be provided based on usage modeling and identification of a user based thereon.

Otherwise, if the usage action is not confirmed, the system may determine that the unconfirmed usage action may be associated with a new usage pattern from the owner of the device or determine that the usage action is from an unauthorized user attempting to access the device in an unauthorized manner. In response to this, one or more security actions or one or more response actions may be taken. For example, one or more parties may be notified, such as the owner of the device. In this way, device security or identity authentication may be promoted and utilization of actions to enhance device responses to the user may thereby offer or provide evolutionary security protection.

The following description and annexed drawings set forth certain illustrative aspects and implementations. These are indicative of but a few of the various ways in which one or more aspects may be employed. Other aspects, advantages, or novel features of the disclosure will become apparent from the following detailed description when considered in conjunction with the annexed drawings.

### BRIEF DESCRIPTION OF THE DRAWINGS

Aspects of the disclosure are understood from the following detailed description when read with the accompanying drawings. Elements, structures, etc. of the drawings may not necessarily be drawn to scale. Accordingly, the dimensions of the same may be arbitrarily increased or reduced for clarity of discussion, for example.

FIG. 1 is an illustration of a component diagram of an example system for usage modeling, according to one or more embodiments.

FIG. 2 is an illustration of an example flow diagram of a method for usage modeling, according to one or more embodiments.

FIG. 3 is an illustration of an example flow diagram of a method for usage modeling, according to one or more embodiments.

FIG. 4 is an illustration of an example flow diagram of a method for usage modeling, according to one or more embodiments.

FIG. 5 is an illustration of example data associated with usage modeling, according to one or more embodiments.

FIG. 6 is an illustration of an example computer-readable medium or computer-readable device including processor-executable instructions configured to embody one or more of the provisions set forth herein, according to one or more embodiments.

FIG. 7 is an illustration of an example computing environment where one or more of the provisions set forth herein are implemented, according to one or more embodiments.

### DETAILED DESCRIPTION

Embodiments or examples, illustrated in the drawings are disclosed below using specific language. It will nevertheless be understood that the embodiments or examples are not intended to be limiting. Any alterations and modifications in the disclosed embodiments, and any further applications of the principles disclosed in this document are contemplated as would normally occur to one of ordinary skill in the pertinent art.

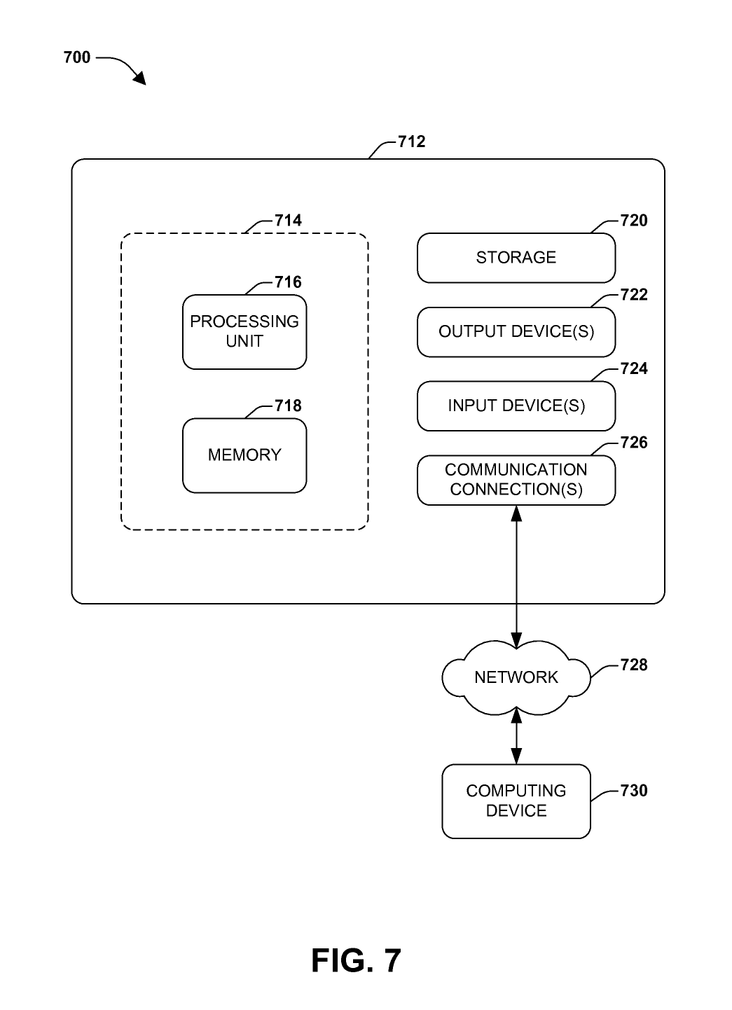

For one or more of the figures herein, one or more boundaries, such as boundary 714 of FIG. 7, for example, may be drawn with different heights, widths, perimeters, aspect ratios, shapes, etc. relative to one another merely for illustrative purposes, and are not necessarily drawn to scale. For example, because dashed or dotted lines may be used to represent different boundaries, if the dashed and dotted lines were drawn on top of one another they would not be distinguishable in the figures, and thus may be drawn with different dimensions or slightly apart from one another, in one or more of the figures, so that they are distinguishable from one another. As another example, where a boundary is associated with an irregular shape, the boundary, such as a box drawn with a dashed line, dotted lined, etc., does not necessarily encompass an entire component in one or more instances. Conversely, a drawn box does not necessarily encompass merely an associated component, in one or more instances, but may encompass a portion of one or more other components as well.

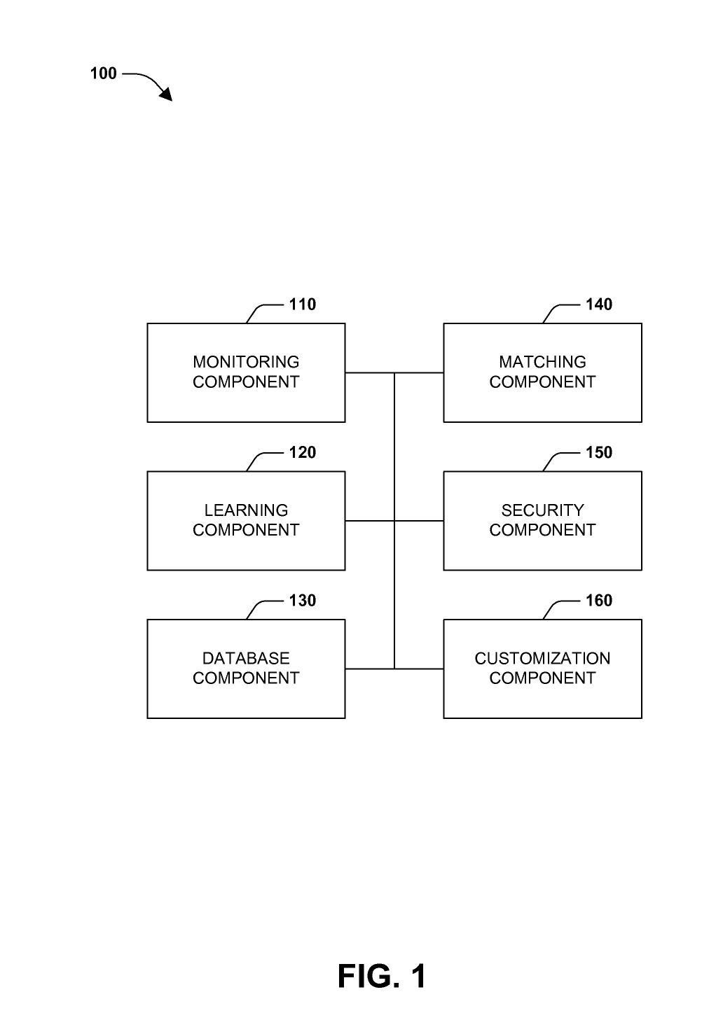

FIG. 1 is an illustration of a component diagram of an example system 100 for usage modeling, according to one or more embodiments. The system 100 of FIG. 1 may be utilized for usage modeling of behaviors, tendencies, actions, gestures, or interactions of one or more users. Actions of one or more users may be monitored and gesture based or action based authentication or identification may be provided based on action recognition or action analysis of one or more actions of a user. Training data may be captured or calculated based on captured data associated with one or more training actions or actions deemed as training actions and action models may be generated accordingly. These action models are generally indicative of how a user performs a predetermined action or otherwise interacts with a device. An identity of a user or authentication may be based thereon. During a usage mode, actions received or associated usage data captured may be utilized to determine a response action or a security action, as will be described in greater detail herein.

The following terms are used throughout the disclosure, the definitions of which are provided herein to assist in understanding one or more aspects of the disclosure.

As used herein, a device may include a mobile device, a cellular device, a smart phone, a device with a touch screen (e.g., a tablet device), a device with a PIN pad (e.g., an automated teller machine or ATM, a home security system, etc.), or a device with one or more input components (e.g., having one or more hardware buttons, software buttons, switches, image capture components, an interface, etc.). A device may include fixtures, such as a doorknob having one or more sensors (e.g., pressure sensor, touch sensors, image capture, etc.) incorporated therein. In other words, a device may include most any system which is capable of detecting how (e.g., by measuring or detecting one or more characteristics) the system is being utilized by a user.

As used herein, usage may include one or more actions taken by one or more users with regard to a device. Generally, usage may include actions, such as a gesture, a wave, an air gesture (e.g., where the gesture is not necessarily in contact with a touch screen or touch screen sensors or captured by image capture, motion sensors, etc.), a touch gesture, a touch, a swipe, an input, an interaction, a passive action, a response, etc. Regardless, usage may include one or more actions associated with a user or taken by a user of a device. It will be appreciated that one or more of the actions may be a passive action or passive (e.g., not necessarily an input directed to the device, a command for the device, or a directive). For example, an action may include when the user holds or grasps a device (e.g., mobile device or smartphone) in his or her hand. As used herein, usage, action, gesture, or the like may be used interchangeably and may be indicative of a relationship or interaction between a user and a device. In other words, usage may be indicative of how an individual or a user utilizes a device on a regular basis or generally, for example. Additionally, usage may include one or more characteristics or one or more attributes associated with an action, such as a delay time between two or more actions (e.g., a time between keystrokes or entries made on a PIN pad, etc.). Actions taken by a user or interactions between the user and a device may be unique to the user, particularly because these actions or interactions may evolve or change throughout the life of the user or device.

As used herein, data, characteristics, attributes, etc. associated with one or more actions may be used interchangeably. Some characteristics, data, or attributes associated with one or more actions may be measured, received, detected, captured, etc., while others may be calculated based on other data or characteristics, such as a captured action. Examples of characteristics or attributes may include device orientation, use position, rotational radian, sliding radian, preferred finger, preferred input area, preferred screen area, preferred touch location, wrist angle, finger angle, sliding angle, contact area, contact location size, contact location shape, touch location size, touch location shape, touch orientation, other touch location features, finger length, length of gesture or action (e.g., measured in distance or time), input frequency, sliding speed, magnitude of pressure, pressing time, pressure at one or more points of an action, time of contact, time between actions, pressing time distribution, one or more other times, speeds, angles, etc. Again, one or more characteristics or one or more attributes associated with an action may be calculated based on one or more other characteristics or one or more other attributes. For example, when a contact location shape or contact location size is detected or determined, a fingertip area or palm size may be calculated accordingly (e.g., based on the contact location shape or contact location size). In this way, a variety of characteristics or attributes may be determined based on measurements received by the monitoring component 110. Further, data may also include gesture data, touch data, training data, usage data (e.g., which is also training data), etc.

As used herein, the term “infer” or “inference” generally refer to the process of reasoning about or inferring states of a system, a component, an environment, a user from one or more observations captured via events or data, etc. Inference may be employed to identify a context or an action or may be employed to generate a probability distribution over states, for example. An inference may be probabilistic. For example, computation of a probability distribution over states of interest based on a consideration of data or events. Inference may also refer to techniques employed for composing higher-level events from a set of events or data. Such inference may result in the construction of new events or new actions from a set of observed events or stored event data, whether or not the events are correlated in close temporal proximity, and whether the events and data come from one or several event and data sources.

The system 100 of FIG. 1 may include a monitoring component 110, a learning component 120, a database component 130, a matching component 140, a security component 150, and a customization component 160. In one or more embodiments, the system 100 may include one or more additional components, such as one or more sensor components or a communications component.

The monitoring component 110 may receive or capture one or more actions (or data associated with one or more of the actions) one or more users has with a device. Additionally, the monitoring component 110 may calculate or derive data associated with one or more of the actions based on one or more of the received actions, captured actions, received data, captured data, etc. As an example, the monitoring component 110 may capture, calculate, or derive training data indicative of one or more training actions between an authorized user and a device or usage data indicative of one or more usage actions between a user (or an unknown user, such as an individual whose identity has not been verified or authenticated) and a device. Training actions may include one or more actions recorded by the monitoring component 110 during a training mode, learning mode, training phase, training scenario, or training period.

It will be appreciated that one or more actions received during a training mode may be deemed or considered training actions while actions received during a use mode may be deemed or considered usage actions. However, in some scenarios, the system 100 may be configured for continuous training such that the use mode and training mode overlap. Here, an action may be both a training action and a usage action. In other words, actions received during such a scenario may be deemed or classified to be a usage action and a training action. It will be appreciated that in other scenarios, an action may be classified or deemed as neither a training action nor a usage action.

In any event, the monitoring component 110 may capture one or more user interactions or actions a user may have with a device. For example, one or more sensors components of a monitoring component 110 may receive one or more actions based on usage associated with a user (who may be an authorized user or a user). One or more of the sensor components may convert aspects or characteristics associated with an action into corresponding data. Examples of sensors or sensor components which may be utilized to detect or measure characteristics or attributes associated with one or more actions may include movement trackers, touch screen sensors, accelerometers, gyroscopes, pressure sensors, gravity sensors, micro-electro-mechanical systems (MEMS), proximity sensors, light sensors, image capture devices, timers, etc. In one or more embodiments, aspects related to one or more of the sensors or sensor components may be adjusted as desired. For example, a sampling rate associated with one or more touch screen sensors may be set to collect different amounts of data (e.g., collecting data at 50 Hz or other frequencies).

Data received, collected, or captured by the monitoring component 110 may be utilized as training data, as usage data, or as both. For example, the monitoring component 110 may receive data during a training mode and also during a usage mode for the system 100. The monitoring component 110 may receive one or more training actions between an authorized user and a device (e.g., during a training mode). Additionally, the monitoring component 110 may receive one or more usage actions between a user (who may or may not be an authorized user) and a device (e.g., during a usage mode). Usage actions may include one or more actions recorded by the monitoring component 110 during a security mode, use mode, usage mode, use phase, use scenario, or use period. To this end usage actions are generally associated with usage data while training actions may be associated with training data.

The learning component 120 may learn how a user interacts with a device by utilizing collected data to build or generate one or more action models. Data associated with one or more actions received by the monitoring component 110 during a training mode may be deemed or considered training data. During the training mode or a learning mode, one or more actions (e.g., or associated data) received or detected by the monitoring component 110 may be utilized to train the learning component 120. Training data, gesture data, or data associated with one or more of the training actions may be utilized by the learning component 120 to build one or more action models. It will be appreciated that not necessarily all actions, data associated therewith, or actions which are detected or captured during a training mode may be incorporated into a corresponding action model. For example, if data associated with an action is determined to be an outlier, that action or associated data may not be included in an action model or stored to the database component 130.

In one or more embodiments, the learning component may build or generate one or more action models based on one or more actions of the user, one or more interactions a user has with a device, or data associated with one or more of the actions. An action model may thus contain or include data which may be indicative of how (e.g., the manner in which) a user utilizes or interacts with a device for a corresponding action or one or more respective actions. Explained another way, an action model may be associated with training data which is characteristic or representative of one or more training actions between an authorized user and a device. The action model may be based on one or more actual actions or observed actions associated with the user or authorized user.

Action models may be generated, trained, or built based on training data or one or more training actions. The learning component 120 may determine, classify, or identify one or more actions of a user, such as by identifying an action. For example, the learning component 120 may identify an action as a swipe from left to right. To this end, the learning component 120 may identify one or more actions received by the monitoring component 110, regardless of whether the action is a usage action or a training action. In this way, the learning component 120 may analyze and correlate training data, such as a left to right swipe to a corresponding action model (e.g., for left to right swipes). Further, the learning component 120 may assign classification tags to one or more action models to facilitate identification of different types of actions.

The learning component 120 may generate one or more action models based one or more training actions, training data, or data associated with one or more of the training actions. These action models may be stored in the database component 130 for reference or to facilitate user identification. It will be appreciated that the learning component 120 may actively prompt a user for one or more training actions (e.g., explicit training) or observe one or more training actions via the monitoring component 110 in a passive manner (e.g., implicit training), without prompting the user.

For example, with regard to explicit training, the learning component 120 may build or generate one or more action models by prompting the user for specific (e.g. predetermined) inputs or training actions during a training mode. In one or more embodiments, a training mode may be defined by the learning component 120, such as during a period of time where user input or training actions are requested. During a training mode, the learning component 120 may provide instructions or requests for a user to perform one or more predetermined actions as training actions. The learning component 120 may prompt a user to swipe up, swipe down, swipe left, swipe right, swipe a predetermined pattern, provide a predetermined gesture, enter a code, enter a PIN, type a phrase, type a word, swipe a word, hold a device in a use position, etc. Other prompts or requests for predetermined training actions may include requests for the user to type on a keyboard, a PIN pad, or dial a telephone number, for example.

Continuing with this example, the monitoring component 110 may receive one or more training actions, associated characteristics, or attributes (e.g., in response to the prompt by the learning component 120) and derive training data from one or more of the training actions. To this end, the learning component 120 may explicitly train one or more action models by prompting a user for one or more training actions or training data. Further, the learning component may populate the database component 130 with one or more of the action models which may include one or more sets of training data. The database component 130 may be populated based on a predetermined action, a prompt for the predetermined action (e.g., by the learning component 120), and one or more corresponding user responses which may be utilized as training actions, for example. The learning component 120 may check or verify one or more of the user responses to ensure the user responses are in accordance with the predetermined action. For example, if the learning component 120 prompts the user to input a PIN, such as ‘1234’ the learning component 120 may check, verify, or require such an input to be provided by the user prior to utilizing the user response as a training action. Accordingly, this verification may ensure that appropriate training actions or training data is being received by the monitoring component 110, thereby enabling the learning component 120 to properly train one or more action models.

In other embodiments (e.g., implicit training), the learning component 120 may build or generate one or more action models without requesting training actions or prompting the user for action. In other words, the learning component 120 may generate one or more of the action models in a passive manner. In these embodiments, one or more actions or data associated therewith may be inferred to be a training action or training data. For example, the monitoring component 110 may observe behaviors, attributes, characteristics, etc. associated with one or more actions or training actions (e.g., where instructions to perform a training action are not given to a user) and generate training data or data associated with one or more of the actions accordingly. Here, the learning component 120 may instruct the monitoring component 110 to report back when the user provide an input to a touch screen which resembles a right swipe, or during a predetermined condition, such as when the device is at a lock screen, for example. Regardless, the learning component 120 may facilitate action model generation based on one or more training actions received from a user.

The database component 130 may store training data, gesture data, data associated with one or more actions or training actions of a user, one or more action models (e.g., where an action model may be associated with the training data or training actions of the user), or other data indicative of how a user utilizes or interacts with a device. It will be appreciated that different actions may be associated with one or more different action models or templates. For example, a first action model may be indicative of how a user swipes from one side of a touch screen to another, while a second action model may be indicative of time of contact a user typically has while providing input to a touch screen (e.g., via a software button). Similarly, a third action model may be indicative of an average time between inputs (e.g., as a gap or a break where the user momentarily does not contact or interact with a device). Other action models may be indicative of other aspects, such as typing speed or input speed, for example.

The database component 130 may store action models in spreadsheet format, utilizing a structured query language (SQL), or other formats, etc. Further, the database component 130 may perform statistical analysis across the training data or on one or more of the action models. For example, the database component 130 may calculate an average time of contact or average swipe pattern for a given swipe or predetermined type of swipe (e.g., left swipe, right swipe, etc.). Additionally, the database component 130 may determine one or more tolerances, thresholds, ranges, acceptable ranges (e.g., +/− one standard deviation for a set of data or training data), etc.

In one or more embodiments, the matching component 140 may detect or determine whether one or more actions or one or more usage actions (e.g. associated with a user) match one or more actions associated with one or more action models (e.g., associated with a known user or an authorized user). The matching component 140 may determine or classify an action or a usage action. For example, after the monitoring component 110 receives an action, corresponding action data, usage action, or corresponding usage data, the matching component 140 may determine what type of action the monitoring component 110 received. For example, an action or usage action may be a swipe, a touch, a grasping action, include a typing input, a swiping input, etc. To this end, the matching component 140 may search the database component 130 for an appropriate (e.g., corresponding) action model to compare the current data set or usage data against. In other words, the matching component 140 may select a corresponding action model based on identification of one or more actions or one or more usage actions.

The matching component 140 may compare one or more usage actions with a corresponding action model. In other words, the matching component 140 may compare usage data associated with one or more usage actions against training data of one or more of the action models (e.g., indicative or representative of one or more training actions or characteristics thereof). Further, the matching component may provide a determination indicative of whether or not an individual utilizing the device during a use mode is an authorized user or is the same user who trained the device during a training mode. In other words, the matching component 140 may determine an identity of a user based on a comparison between usage data and training data. In this way, the matching component 140 may provide a ‘passing’ or ‘failing’ determination for one or more usage actions. It will be appreciated that comparing one or more of the usage actions with a corresponding action model may include comparing usage data of one or more of the usage actions with training data of the corresponding action model.

The matching component 140 may generate one or more matching algorithms to facilitate matching or a comparison between training data of one or more action models and usage data. One or more of the matching algorithms may utilize pattern recognition, machine learning, principal component analysis (PCA), convex pattern matching, or other algorithms, etc. A matching algorithm may facilitate determining whether a usage action is similar to a training action which was previously recorded or captured, thereby indicating whether or not the current user is the owner of the device, the same individual who trained the device, or otherwise authorized to utilize the device. To this end, when a comparison indicates that a usage action is similar to a training action, this may be considered a ‘pass’ or ‘passing’. Conversely, if the usage action is dissimilar from the training action, this may be considered a ‘fail’ or ‘failing’, thereby indicating that the individual or user currently utilizing the device may be someone other than the owner of the device. One or more of the matching algorithms may be stored within the database component 130.

The matching component 140 may analyze one or more actions as a group or as a set. For example, a set of seven (although most any number is contemplated) actions may be analyzed by the matching component 140 where a determination that a user is an authorized user may be based on a scenario where four or more of the actions ‘pass’ the comparison against respective action models. In other words, the matching component 140 may authenticate a user based on a threshold number of matches between one or more usage actions and a corresponding action model.

It will be appreciated that different types of attributes or characteristics may be analyzed as part of a set or part of a group. For example, when a user is at an unlock screen for a mobile device (e.g., where the user is required to enter a PIN to acquire access to the mobile device), the matching component 140 may utilize multiple characteristics, such as typing speed, time of contact, fingertip area, fingertip shape, etc. to generate the determination. In other words, the matching component 140 may ‘pass’ or ‘fail’ sets of actions or groups of actions based on different combinations of attributes or characteristics. In one or more embodiments, a combination of characteristics may be randomly selected, while other embodiments may utilize a predetermined combination of characteristics. In this way, false positives or false negatives may be mitigated.

The security component 150 may enable a security mode or a usage mode for the system 100 when a threshold number of action models are populated within the database component 130. As an example, when fifty action models are developed by the learning component 120, the security component 150 may enable gesture analysis or place the system 100 in security mode or usage mode. Here, one or more actions or a set of one or more actions may be considered usage actions and corresponding usage data may be derived or calculated therefrom. This usage data may be compared against training data of one or more action models for corresponding actions (e.g., comparing left swipe usage data against left swipe training data from a left swipe action model). In other words, current user interactions with a device may be tested against existing interaction data from action models developed during a training mode.

In one or more embodiments, the security component 150 may test or compare usage data derived from one or more actions, current actions, or usage actions against training data associated with one or more action models developed by the learning component 120 and control or manage device security accordingly. For example, the security component 150 may enable or disable security or access to one or more components, one or more portions, or an interface of the device based on the comparison, test, or a match between one or more usage actions and a corresponding action model.

If one or more usage actions do not closely enough match (e.g., within a range or threshold) usage data of one or more of the action models, the security component 150 may disable a device as a security response. In other words, the security component 150 may provide a security action or a response action based on a threshold difference or disparity between one or more usage actions or associated usage data and one or more action models or associated training data. In this way, the security component 150 may provide one or more responses actions based on a comparison between the usage data and the training data. A response action or a security action may include disabling one or more portions or components of a device, locking the device, notifying one or more parties (e.g., based on text, email, or other communications), tagging usage activity, etc. For example, one or more of the parties may be notified based on a difference or threshold difference between one or more usage actions and a corresponding action model. Similarly, one or more of the parties may be notified based on a difference or threshold difference between usage data and training data of one or more action models.

In one or more embodiments, a customization component 160 may provide personalization when an identity of a user is confirmed by the matching component 140 or when a user is determined to be an authorized user. For example, when usage data of one or more usage actions are determined to be similar or matching one or more action models, the customization component 160 may determine that the user utilizing the device is the same user as the user who trained the device, and is thus authorized to access the device. To this end, the customization component 160 may provide one or more interfaces or associate the user's experience with one or more customizations, such as by incorporating aspects from a user profile with an interface of the device. In other words, when the matching component 140 determines or confirms the identity of a user (e.g., determines that the user is an authorized user based on a match between usage data and training data or an action model), the customization component 160 may tailor the user experience associated with the device for the user to be personalized by providing a custom or personalized interface, etc.

The customization component 160 may be implemented for multi-user devices. For example, a remote control equipped with one or more sensors may provide one or more actions, one or more training actions, or associated data to the monitoring component 110 and have the learning component 120 generate one or more action models for a user. When a user utilizing the remote control acts in a manner which matches the training actions or training data of an action model (e.g., or is identified based on his or her utilization of the remote by the matching component 140), the customization component 160 may render one or more favorites associated with the user, login to an account associated with the user, or integrate a profile of the user based on confirmation of the user's identity (e.g., verified utilizing one or more usage actions provided by the user).

Generally, the system 100 learns different behaviors of a user (e.g., authorized user) during a training mode and develops action models which may be utilized to identify the user during a usage mode or security mode. Although the training mode generally chronologically occurs prior to the usage mode, the training mode may overlap with the usage mode according to one or more embodiments. In other words, the training mode does not necessarily have to be distinct from the usage mode. Stated another way, the learning component 120 may engage in training or learning during a security or use mode for the system 100. For example, an action may be utilized as a usage action and also be utilized as a training action. In this way, the system 100 may be configured such that training occurs in an ongoing manner, thereby facilitating the evolution of one or more of the action models and updating the training data.

In one or more embodiments, the learning component 120 may continually update the database component 130, one or more actions models, one or more training actions, or associated training data with usage data from one or more usage actions which represent a gradual shift or change in the way a user utilizes his or her device. Because a user may change the way he or she interacts with a device, the learning component 120 may update one or more of the action models by replacing older action models with newer or updated action models indicative of new usage patterns associated with a user. For example, when a set of usage actions includes one or more ‘passing’ usage actions (e.g., when a majority of usage actions or a threshold number of usage actions are determined to be ‘passing’ actions), one or more of these ‘passing’ usage actions may be added to an action model or a new action model (e.g., which may replace an older action model) or utilized to update one or more portions of one or more older action models.

For example, for a set of seven actions (although other numbers may be used), one or more of the seven actions may be utilized to generate an action model when four or more of the seven actions match an existing action model are determined to ‘pass’ gesture analysis or are deemed authorized by the matching component 140. In this way, the learning component 120 may facilitate evolution of the action models or maintain updated training data. Accordingly, the training mode, learning mode, training period, etc. may be indefinite or extended according to one or more embodiments. In one or more embodiments, new action models may overwrite or replace one or more older or stale action models (e.g., an action model generated during a training mode or an initial training phase). In other embodiments, one or more portions of an action model may be updated based on one or more ‘passing’ usage actions. For example, an action model may include a set training data relating to one hundred actions determined to be the same action (e.g., one hundred sets of data for a hundred left swipes a user has performed). Incoming training data may replace the oldest training data of the action model. As an example, if seven of seven usage actions are deemed passing by the matching component 140, data associated with those seven usage actions may replace the seven oldest sets of training data for a corresponding action model. Further, when an action model is updated or when the database component 130 is updated, one or more parameters associated with a matching algorithm may be recalculated.

One or more example embodiments are provided to facilitate additional understanding of this disclosure. One or more of these embodiments will be described with reference to the numbering provided in FIG. 1.

In one or more embodiments, an orientation of a device or a use position of a device may be utilized as usage or as a training action to generate an action model to facilitate security for a device. For example, if an individual generally holds a mobile device, such as a smartphone, at a particular angle (e.g., during a usage scenario, such as a telephone conversation when a speakerphone of the mobile device is off or otherwise when the mobile device is in use and being held against the user's ear, etc.), that angle or one or more aspects associated with the orientation may be detected or captured by the monitoring component 110. The monitoring component 110 may include one or more sensor components or may receive information from sensor components. Here, orientation data or training orientation data associated with the mobile device may be measured utilizing an accelerometer, 3-dimensional (3D) accelerometer, or a gyroscope of the mobile device. The learning component 120 may develop or generate one or more action models (e.g., associated with the action of holding or grasping the mobile device) and store one or more of the action models within the database component 130.

Accordingly, when the mobile device is in use, such as during in a future telephone conversation, or the like (e.g., other use scenarios or similar scenarios, such as during a call or a communication and the speakerphone is off or when the device is in a use position against a user's ear, etc.), the monitoring component 110 may detect a use angle, a current orientation, orientation data associated with usage of the device, usage orientation data, etc., may be received from one or more sensor components or by the monitoring component 110. This usage orientation data may be compared against the training orientation data of an action model associated with the angle at which a user engages in utilization of the device by the matching component 140.

If the use angle or usage orientation data is within a threshold range of the training orientation data (e.g., the orientation data which was utilized to train the system 100 or model the action model of the database component 130), no response action or security action may be taken (e.g., no action required) according to one or more embodiments. In other words, when the matching component 140 determines that the data from a usage scenario closely matches (e.g., based on one or more matching algorithms, etc.) data from a training mode or training scenario, a user utilizing the device in the usage scenario is likely the same user utilizing the device in the training mode or training scenario. Here, because the usage orientation data is within the threshold range of the training orientation data, the matching component 140 may determine that it is likely that the same user is utilizing the mobile device between the training and usage modes. Accordingly, security action (e.g., to lock a user out from a device) or a response action is not required.

However, in other scenarios, if the usage orientation data or usage angle exceeds a threshold difference, is outside of the threshold range of the training orientation data, or differs greatly from the corresponding action model, etc., the security component 150 may initiate one or more response actions or one or more security actions. When the data from the usage scenario does not closely match data from the training mode or a training scenario, there is a greater likelihood that the user utilizing the device in the usage scenario may not be the same user as the user who utilized the device during the training mode, training phase, or training scenario. To this end, the matching component 140 may determine that it is likely that the user utilizing the mobile device during the usage scenario or use mode is different than the user utilizing the same mobile device. As a result of this, the security component 150 may initiate one or more response actions or one or more security actions. For example, a response action or security action may include not permitting a telephonic communication to be placed, tagging an associated use action, transmitting an alert or notification to one or more parties, asking for additional verification information (e.g., please re-enter a PIN or password), etc.

As another example, one or more touch screen sensors or sensing components on a device may utilize touch data from a touch screen of a device to determine an identity of a user interacting with or utilizing the device. The touch screen sensors may provide the monitoring component 110 with raw data, such as touch location coordinates, pressure of a touch, size of a touch, shape of a touch, orientation of a touch. From this raw data the monitoring component 110 may calculate or derive most any other data, thereby providing the system 100 with training touch data. During a training mode, a monitoring component 110 may receive touch data or training touch data indicative of a shape of a touched location from one or more touch screen sensors or other sensing components when a user touches a touch screen of a device. For example, the training touch data or touch data may include data regarding a location on the touch screen where the user touched the screen, a shaped of the touched location (e.g., measured as an ellipse), a size of the touched location, time of contact associated with the touch, other contact data, etc.

The learning component 120 may generate one or more action models based on this training touch data. The learning component 120 may generate an action model pertaining to locations on a touch screen the user touches on a frequent basis. As an example, the learning component 120 may generate an action model associated with an area of a software button (e.g., spacebar) where a user typically strikes during typing or software keyboard use. If a user generally utilizes the spacebar with his or her right hand or right thumb, one or more signatures or patterns may be observed, and corresponding action models generated. Continuing with this example, a right thumb may have a touch area shaped similarly to a backslash (e.g., as opposed to a forward slash orientation or shape which may be associated with a left finger). Additionally, a thumb may occupy a greater or larger amount of area than other digits or fingers.

Another aspect which may be incorporated into an action model is the location at which the user strikes the spacebar or key on the keyboard or software keyboard. For example, if the user is utilizing his or her right hand to type on a key (e.g., a spacebar in the center of the keyboard), the monitoring component 110 may record one or more striking locations associated with the key. Because the spacebar is in the center of the keyboard, a user may tend to utilize the right hand portion or right hand touch screen area of the spacebar if he or she typically strikes the space bar with his or her right hand. Other aspects may provide for different action models for different words. For example, a user may utilize his or her right hand for a character of a word, phrase, or sentence and his or her left hand for the same character of a different word, phrase, or sentence. These action models may be stored in the database component 130.

During a use mode (e.g., a security mode, usage mode, use phase, use scenario), the monitoring component 110 may continue to receive touch data or usage touch data based on one or more usage actions taken by a user. Again, touch data or usage touch data may include data regarding a location on the touch screen where the user touched the screen, a shaped of the touched location (e.g., measured as an ellipse), a size of the touched location, time of contact associated with the touch, other contact data, etc. It will be appreciated that the training touch data may be utilized to train one or more action models while the usage touch data may be indicative of more current touch data from an individual. Additionally, the usage touch data is generally received during a use mode or security mode. Here, the usage touch data may be received by sensor components, such as a touch screen sensor of a device or by the monitoring component 110.

The usage touch data may be compared against corresponding training touch data from one or more action models from the database component 130 to determine an identity of the individual. If the training data (e.g., training touch data) closely resembles or closely matches the usage data (e.g., usage touch data), the identity of the individual may be confirmed to be the same as the user associated with the training data. In one or more embodiments, the matching component 140 may utilize one or more matching algorithms, one or more thresholds, or one or more range comparisons to facilitate matching or comparisons between one or more action models or training data and usage data. In other words, the matching component 140 may determine identity of an individual based on a set of training data or action models associated with a known user or known individual, usage data associated with the individual, and one or more matching algorithms. As an example, if the shape, size, positioning, etc. of a user's finger does not match (e.g., outside of an acceptable range or threshold as determined by the matching component 140 or a matching algorithm) a profile or action model associated with a similar action, one or more response actions or security actions may be taken. A response action may include a security action.

For example, if a user is attempting to enter a PIN on a lock screen of a device, a security component 150 may deny the user access to the device (e.g., or one or more aspects associated with the device) based on the usage data or current usage data. In the above mentioned example, the usage data included usage touch data associated with a touch screen. To this end, the security component 150 may deny access to a user based on the usage data and the training data not matching in accordance with a matching algorithm. In other words, the security component 150 may deny the user access to the device even when the user has correctly entered the PIN at the lock screen due to other factors or aspects related to differences between the training data and the usage data.

Embodied in another example, if the training data indicates that a user typically enters a four digit PIN within a time frame or time range (e.g., action model or training data associated with time to enter a PIN) and a correct PIN is entered (e.g., usage data or usage action) outside of that time frame or an acceptable or predetermined time range, the security component 150 may deny access or take other responsive action, such as requesting the individual or user to re-enter the PIN. Regardless, the security component 150 may take one or more response actions based on a comparison between usage data from one or more usage actions and training data or a corresponding action model from one or more training actions. Stated another way, the security component 150 may grant or deny access (e.g., or take one or more response actions) based on current usage (e.g., usage associated with a use mode or security mode) and previously modeled usage (e.g., usage or actions modeled during a training mode). It will be appreciated, however, that the training mode may be ongoing or continually in operation, as discussed herein.

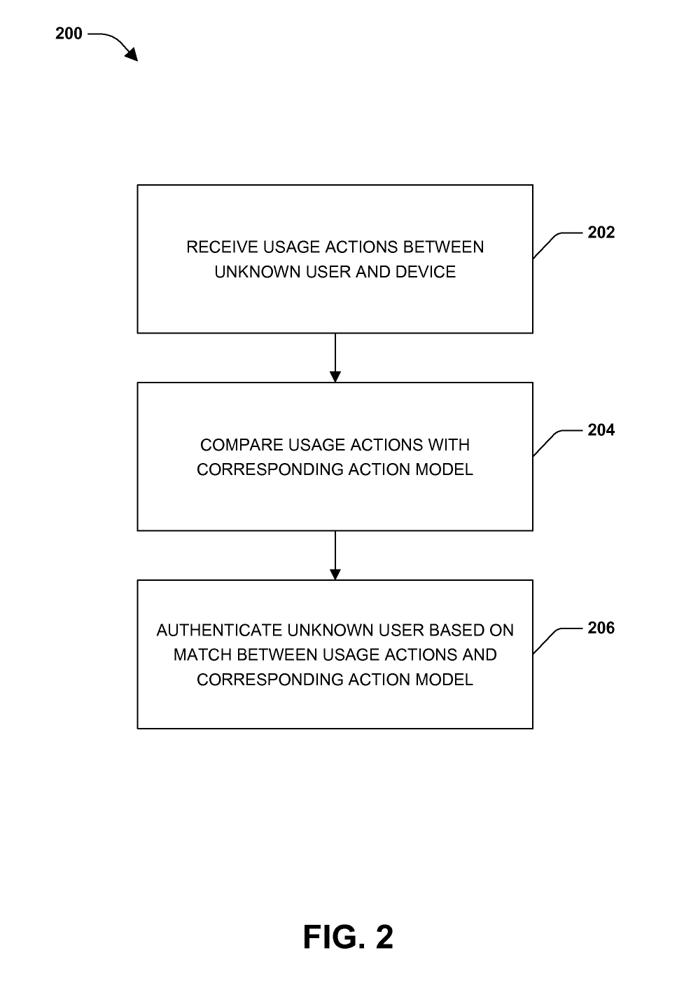

FIG. 2 is an illustration of an example flow diagram of a method 200 for usage modeling, according to one or more embodiments. At 202, one or more usage actions may be received. Usage actions may be actions or interactions between a user and a device. At 204, one or more of the usage actions may be compared with one or more corresponding action models, which may include training data indicative or characteristic of one or more training actions of an authorized user or user who trained the device. At 206, the user may be authenticated or identity verified based on a match between one or more of the usage actions and one or more corresponding action models.

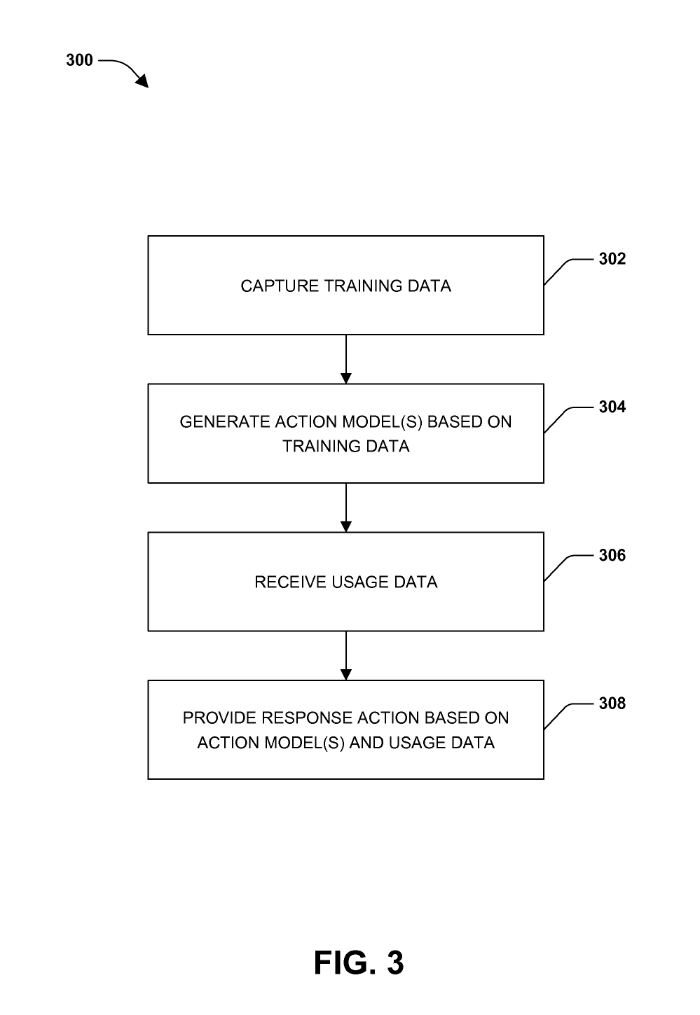

FIG. 3 is an illustration of an example flow diagram of a method 300 for usage modeling, according to one or more embodiments. At 302, training data may be captured. At 304, the training data may be utilized to generate one or more actions models. At 306, usage data may be received, such as from one or more usage actions or calculated from one or more of the usage actions. At 308, one or more response actions or security actions may be provided based on one or more of the action models and the usage data.

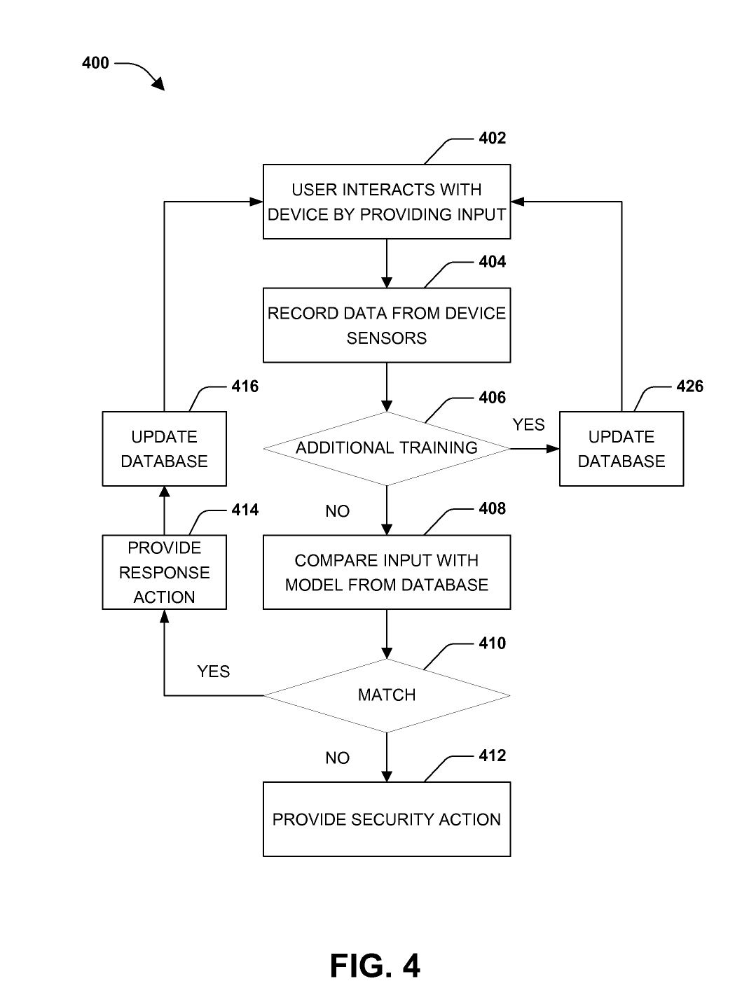

FIG. 4 is an illustration of an example flow diagram of a method 400 for usage modeling, according to one or more embodiments. At 402, a user may interact with a device. The user may provide one or more inputs or one or more actions for the device. As mentioned, an action may include passive action, such as holding a device, for example. At 404, sensors on the device may record data associated with one or more of the actions or inputs of 402. At 406, if additional models are to be trained or if a database requires additional populating, the database or action models may be updated at 426 and the method may return to 402. If the device is in a usage mode or otherwise does not require additional training, the user input or action may be compared against an action model from a database at 408. At 410, if the comparison ‘fails’, the method 400 continues to provide a security response or security action at 412. If the comparison at 410 ‘passes’, a response action may be provided at 414. Additionally, the ‘passing’ input or action may be used to update the database at 416. Further interaction may be recorded at 402.

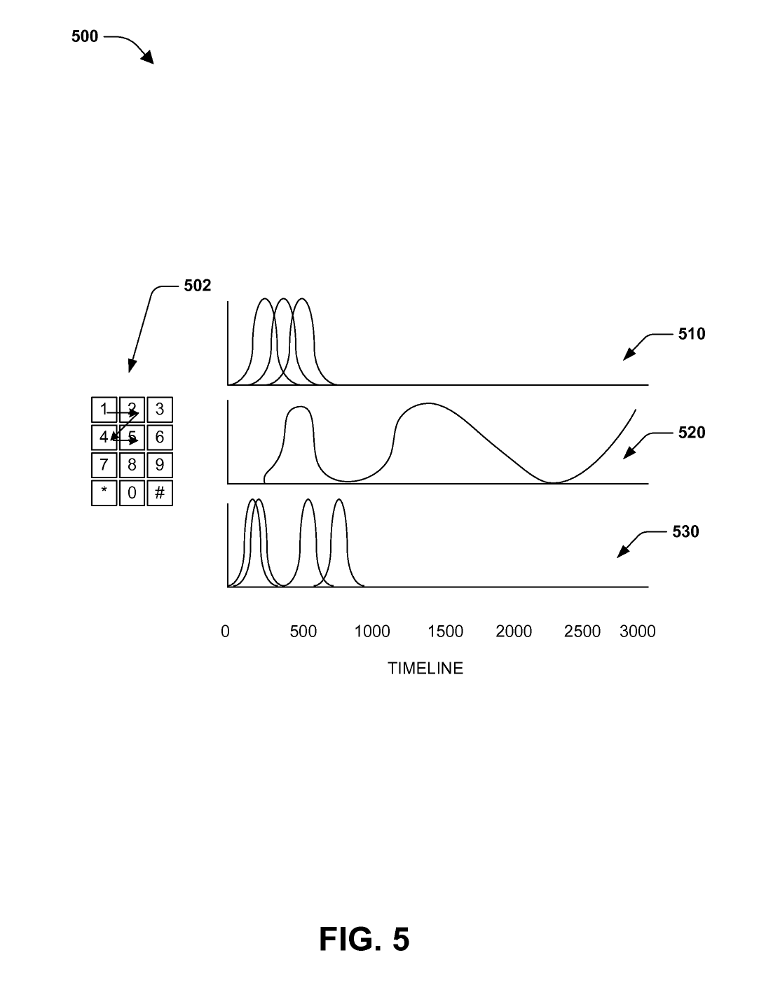

FIG. 5 is an illustration 500 of example data associated with usage modeling, according to one or more embodiments. In FIGS. 5, 510, 520, and 530 are graphs of pressing time distributions (PTD) of a first user, a second user, and a third user, respectively. The three users were asked to enter the same password (e.g., 1245) as seen at 502. It can be seen that each of the users contacts a digit of the password at different points in time and for different amounts of time, cumulatively. As an example, it appears that the first user took around 1000 milliseconds to enter the password, while the second user took around 3000 milliseconds, and the third user took around 1400 milliseconds. Similarly, the amount of time each user spent on each digit or pauses or breaks between each digit may be analyzed or recorded. To this end, a monitoring component (e.g., the monitoring component 110 of FIG. 1) may analyze, record, or capture such data to facilitate usage modeling and identification or an authentication scheme based thereon.

One or more embodiments may employ various artificial intelligence (AI) based schemes for carrying out various aspects thereof. One or more aspects may be facilitated via an automatic classifier system or process. A classifier is a function that maps an input attribute vector, x=(x1, x2, x3, x4, xn), to a confidence that the input belongs to a class. In other words, f(x)=confidence (class). Such classification may employ a probabilistic or statistical-based analysis (e.g., factoring into the analysis utilities and costs) to prognose or infer an action that a user desires to be automatically performed.

A support vector machine (SVM) is an example of a classifier that may be employed. The SVM operates by finding a hypersurface in the space of possible inputs, which the hypersurface attempts to split the triggering criteria from the non-triggering events. Intuitively, this makes the classification correct for testing data that may be similar, but not necessarily identical to training data. Other directed and undirected model classification approaches (e.g., naïve Bayes, Bayesian networks, decision trees, neural networks, fuzzy logic models, and probabilistic classification models) providing different patterns of independence may be employed. Classification as used herein, may be inclusive of statistical regression utilized to develop models of priority.

One or more embodiments may employ classifiers that are explicitly trained (e.g., via a generic training data) as well as classifiers which are implicitly trained (e.g., via observing user behavior, receiving extrinsic information). For example, SVMs may be configured via a learning or training phase within a classifier constructor and feature selection module. Thus, a classifier may be used to automatically learn and perform a number of functions, including but not limited to determining according to a predetermined criteria.

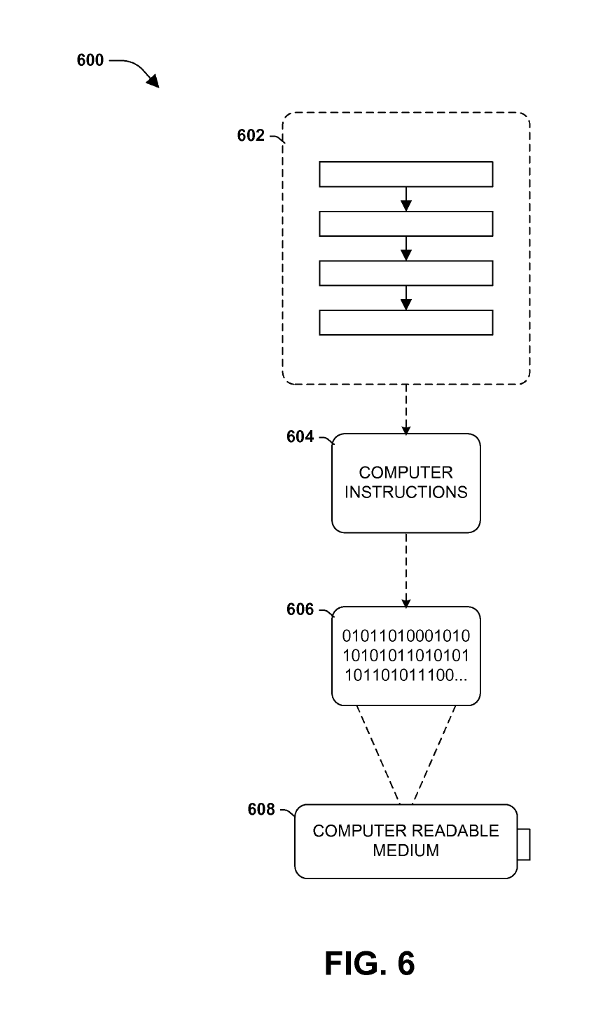

Still another embodiment involves a computer-readable medium including processor-executable instructions configured to implement one or more embodiments of the techniques presented herein. An embodiment of a computer-readable medium or a computer-readable device devised in these ways is illustrated in FIG. 6, wherein an implementation 600 includes a computer-readable medium 608, such as a CD-R, DVD-R, flash drive, a platter of a hard disk drive, etc., on which is encoded computer-readable data 606. This computer-readable data 606, such as binary data including a plurality of zero's and one's as shown in 606, in turn includes a set of computer instructions 604 configured to operate according to one or more of the principles set forth herein. In one such embodiment 600, the processor-executable computer instructions 604 may be configured to perform a method 602, such as the method 200 of FIG. 2, the method 300 of FIG. 3, or the method 400 of FIG. 4. In another embodiment, the processor-executable instructions 604 may be configured to implement a system, such as the system 100 of FIG. 1. Many such computer-readable media are devised by those of ordinary skill in the art that may be configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

FIG. 7 and the following discussion provide a description of a suitable computing environment to implement embodiments of one or more of the provisions set forth herein. The operating environment of FIG. 7 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, embodiments are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 7 illustrates a system 700 including a computing device 712 configured to implement one or more embodiments provided herein. In one configuration, computing device 712 includes at least one processing unit 716 and memory 718. Depending on the exact configuration and type of computing device, memory 718 may be volatile, such as RAM, non-volatile, such as ROM, flash memory, etc., or a combination of the two. This configuration is illustrated in FIG. 7 by dashed line 714.

In other embodiments, device 712 includes additional features or functionality. For example, device 712 may include additional storage such as removable storage or non-removable storage, including, but not limited to, magnetic storage, optical storage, etc. Such additional storage is illustrated in FIG. 7 by storage 720. In one or more embodiments, computer readable instructions to implement one or more embodiments provided herein are in storage 720. Storage 720 may store other computer readable instructions to implement an operating system, an application program, etc. Computer readable instructions may be loaded in memory 718 for execution by processing unit 716, for example.

The term “computer readable media” as used herein includes computer storage media. Computer storage media includes volatile and nonvolatile, removable and non-removable media implemented in any method or technology for storage of information such as computer readable instructions or other data. Memory 718 and storage 720 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by device 712. Any such computer storage media is part of device 712.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

Device 712 includes input device(s) 724 such as keyboard, mouse, pen, voice input device, touch input device, infrared cameras, video input devices, or any other input device. Output device(s) 722 such as one or more displays, speakers, printers, or any other output device may be included with device 712. Input device(s) 724 and output device(s) 722 may be connected to device 712 via a wired connection, wireless connection, or any combination thereof. In one or more embodiments, an input device or an output device from another computing device may be used as input device(s) 724 or output device(s) 722 for computing device 712. Device 712 may include communication connection(s) 726 to facilitate communications with one or more other devices.

According to one or more aspects, a method for usage modeling is provided, including receiving one or more usage actions between a user and a device, comparing one or more of the usage actions with a corresponding action model, and authenticating the user based on a match between one or more of the usage actions and the corresponding action model. The method may include identifying one or more of the usage actions or selecting the corresponding action model based on identification of one or more of the usage actions.

In one or more embodiments, one or more of the usage actions may be associated with usage data. The corresponding action model may be associated with training data indicative of one or more training actions between an authorized user and the device. Comparing one or more of the usage actions with the corresponding action model may include comparing usage data of one or more of the usage actions with training data of the corresponding action model. The corresponding action model may be indicative of how an authorized user interacts with the device for a corresponding action.

The method may include providing access to one or more portions of the device based on determining the match between one or more of the usage actions and the corresponding action model, denying access to one or more portions of the device based on a difference between one or more of the usage actions and the corresponding action model, or notifying one or more parties based on a threshold difference between one or more of the usage actions and the corresponding action model.

According to one or more aspects, a system for usage modeling is provided, including a monitoring component for capturing one or more actions between one or more users and a device, a learning component for building one or more action models based on one or more training actions of one or more of the actions, a database component for storing one or more of the action models.

The monitoring component may calculate training data for one or more of the training actions captured by the monitoring component during a training mode, wherein one or more of the training actions is between an authorized user and the device. The monitoring component may calculate usage data for one or more usage actions captured by the monitoring component during a usage mode, wherein one or more of the usage action is between a user and the device. The system may include a matching component for comparing the usage data with training data from one or more of the action models. The matching component may determine an identity of the user based on the comparison between the usage data and the training data. The system may include a security component for providing one or more response actions based on the comparison between the usage data and the training data.

According to one or more aspects, computer-readable storage medium including computer-executable instructions, which when executed via a processing unit on a computer performs acts including capturing training data indicative of one or more training actions between an authorized user and a device, generating one or more action models based on the training data, receiving usage data indicative of one or more usage actions between a user and the device, and providing a response action based on one or more of the action models and the usage data. Additionally, the response action may include granting access to the device or denying access to the device or notifying one or more parties based on a difference between the usage data and training data of one or more of the action models. One or more of the action models may be indicative of how the authorized user interacts with the device for one or more respective actions.

Although the subject matter has been described in language specific to structural features or methodological acts, it is to be understood that the subject matter of the appended claims is not necessarily limited to the specific features or acts described above. Rather, the specific features and acts described above are disclosed as example embodiments.

Various operations of embodiments are provided herein. The order in which one or more or all of the operations are described should not be construed as to imply that these operations are necessarily order dependent. Alternative ordering will be appreciated based on this description. Further, not all operations may necessarily be present in each embodiment provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

Although the disclosure has been shown and described with respect to one or more implementations, equivalent alterations and modifications will occur based on a reading and understanding of this specification and the annexed drawings. The disclosure includes all such modifications and alterations and is limited only by the scope of the following claims.

What is claimed is:

1. A method for usage modeling, comprising:
receiving one or more usage actions between a user and a device;
comparing one or more of the usage actions with a corresponding action model; and
authenticating the user based on a match between one or more of the usage actions and the corresponding action model, wherein the receiving, the comparing, or the authenticating is implemented via a processing unit.

2. The method of claim 1, comprising identifying one or more of the usage actions.

3. The method of claim 2, comprising selecting the corresponding action model based on identification of one or more of the usage actions.

4. The method of claim 1, wherein one or more of the usage actions is associated with usage data.

5. The method of claim 1, wherein the corresponding action model is associated with training data indicative of one or more training actions between an authorized user and the device.

6. The method of claim 1, wherein comparing one or more of the usage actions with the corresponding action model comprises comparing usage data of one or more of the usage actions with training data of the corresponding action model.

7. The method of claim 1, wherein the corresponding action model is indicative of how an authorized user interacts with the device for a corresponding action.

8. The method of claim 1, comprising providing access to one or more portions of the device based on determining the match between one or more of the usage actions and the corresponding action model.

9. The method of claim 1, comprising denying access to one or more portions of the device based on a difference between one or more of the usage actions and the corresponding action model.

10. The method of claim 1, comprising notifying one or more parties based on a threshold difference between one or more of the usage actions and the corresponding action model.

11. A system for usage modeling, comprising:
a monitoring component for capturing one or more actions between one or more users and a device;
a learning component for building one or more action models based on one or more training actions of one or more of the actions; and
a database component for storing one or more of the action models, wherein the monitoring component, the learning component, or the database component is implemented via a processing unit.

12. The system of claim 11, wherein the monitoring component calculates training data for one or more of the training actions captured by the monitoring component during a training mode, wherein one or more of the training actions is between an authorized user and the device.

13. The system of claim 11, wherein the monitoring component calculates usage data for one or more usage actions captured by the monitoring component during a usage mode, wherein one or more of the usage action is between a user and the device.

14. The system of claim 13, comprising a matching component for comparing the usage data with training data from one or more of the action models.

15. The system of claim 14, wherein the matching component determines an identity of the user based on the comparison between the usage data and the training data.

16. The system of claim 14, comprising a security component for providing one or more response actions based on the comparison between the usage data and the training data.

17. A computer-readable storage medium comprising computer-executable instructions, which when executed via a processing unit on a computer performs acts, comprising:
capturing training data indicative of one or more training actions between an authorized user and a device;
generating one or more action models based on the training data;
receiving usage data indicative of one or more usage actions between a user and the device; and
providing a response action based on one or more of the action models and the usage data.

18. The computer-readable storage medium of claim 17, wherein the response action comprises granting access to the device or denying access to the device.

19. The computer-readable storage medium of claim 17, wherein the response action comprises notifying one or more parties based on a difference between the usage data and training data of one or more of the action models.

20. The computer-readable storage medium of claim 17, wherein one or more of the action models is indicative of how the authorized user interacts with the device for one or more respective actions.
